(19) United States
(12) Patent Application Publication
(10) Pub. No.: US 2005/0207026 A1
(43) Pub. Date: Sep. 22, 2005

(54) Optical module and camera module

(76) Inventors: Takayuki Satodate, Chiba-shi (JP); Haruhiko Hasegawa, Chiba-shi (JP); Makoto Suzuki, Chiba-shi (JP); Akira Kume, Chiba-shi (JP)

Correspondence Address: BRUCE L. ADAMS, ESQ., 50 BROADWAY-31ST FLOOR, NEW YORK, NY, 10004, US

(21) Appl. No.: 11/063,467

(22) Filed: Feb. 22, 2005

(30) Foreign Application Priority Data
Feb. 24, 2004 (JP) 2004-047949
Feb. 2, 2005 (JP) 2005-026748

(51) Int. Cl. G02B 15/14

(52) U.S. Cl. 359/696

(57) ABSTRACT

Provided is an optical module that is thin, allows freedom of design in configuration, and assures the accuracy of movement of an optical part while suppressing power loss. A stepping motor 26 and a lens barrel 27 that is moved by moving means 28 are positioned offset from each other along a base plate 23, and the optical axis of the lens barrel 27 and the axis of a rotor 37 provided in the stepping motor 26 are arranged in parallel with each other on one surface of the base plate 23. Further, a reduction gear train 29, which operatively couples the rotor 37 and the moving means 28 together, is arranged on the one surface. The stepping motor 26 consists of a flat-shaped motor equipped with: coil blocks 35 each having an excitation coil 39 horizontally mounted along the base plate 23; a yoke 36 whose magnetic path portion 36a excluding end portions 36b and 36c connected with the coil blocks 35 is provided so as not to overlap the coil blocks 35; and the rotor 37 arranged within a rotor pass-through hole 40 of the yoke 36.

### BACKGROUND OF THE INVENTION

1. Field of the Invention

The present invention relates to an optical module equipped with an optical part that is moved for focus adjustment, zooming, and the like, and more particularly to an optical module and a camera module suitable for being mounted on thin electronic apparatuses such as a card-type digital camera or a camera-equipped portable telephone.

2. Description of the Related Art

Conventionally, there is known a lens driver (optical module) in which, in order to move a lens barrel holding a lens to effect focus adjustment, the drive shaft of a tubular stepping motor is formed by a feed screw, and a rack member protruding from a lens barrel holder holding the lens barrel is brought into mesh with the feed screw, with the lens barrel being moved along an optical axis thereof through the intermediation of the rack member as the stepping motor rotates in forward and reverse directions, thereby effecting a focusing operation (refer to, for example, JP 3-294809 A).

Further, it has been also proposed to adopt a tubular stepping motor of so-called horizontal mounting arrangement in which the axis of the tubular stepping motor becomes perpendicular to the optical axis, unlike that of so-called vertical mounting arrangement in which, as in JP 3-294809 A, the axis of the tubular stepping motor becomes parallel to the optical axis (see FIGS. 9 and 10).

Arranged between a base plate and a cover, respectively denoted by reference numerals 1 and 2 in FIGS. 9 and 10, is a lens barrel holder 4 that is movable along a plurality of guide shafts 3 extending between the base plate 1 and the cover 2 and urged by a coil spring 3a. The holder 4 holds a lens barrel 5 having a plurality of lenses. Attached to the base plate 1 in an opposing relation to the lens barrel 5 is a circuit board 7 on which an image pickup element 6 is mounted. A tubular stepping motor 8 is mounted to the base plate 1 so as to be spaced apart from the lens barrel 4. The stepping motor 8 is mounted horizontally with its drive shaft Ba extending parallel to the surface of the base plate 1. A worm 9 is fixed to the drive shaft 8a. A feed screw 10 provided between the base plate 1 and the cover 2 extends through an outwardly protruding portion 4a of the lens barrel holder 4, with a worm wheel 11 fixed to the feed screw 10 being in mesh with the warm 9. Fixed to the outwardly protruding portion 4a is a nut member 12, which is in mesh with the feed crew 10.

Accordingly, upon driving the stepping motor 8, the drive torque is reduced and has its transmission direction shifted by 90 degrees through a worm gear (the worm 9 and the worm wheel 11) as it is transmitted to the feed screw 10. The lens barrel 5 is thus moved along the optical axis through the intermediation of the lens barrel holder 4 based on the meshing between the rotating feed screw 10 and the nut member 12, thereby effecting focusing operation.

Since the technique as disclosed in JP 3-294809 A adopts a vertical mounting arrangement for the tubular stepping motor, the length of the motor body constituting the tubular shape of the stepping motor takes up a large proportion in the thickness direction of the lens driver serving as an optical module, making the technique disadvantageous for realizing a thin construction of the lens driver. In contrast, the examples shown in FIGS. 9 and 10, in which the tubular stepping motor 8 is mounted in the horizontal position, are preferable because it is possible to prevent an increase in the thickness of the lens driver as an optical module due to the length of the motor body constituting the tubular shape. However, the worm gear, which effects power transmission by obtaining a large reduction ratio with one gear stage while permitting a slip between the worm 9 and the worm wheel 11, involves a large power loss, making it necessary for the stepping motor 8 used to generate a large torque.

Further, the movement of an optical part such as a lens barrel requires precision. For this reason, a rotor equipped in the tubular stepping motor is magnetized with multiple poles, and a tubular stator accommodating this rotor has a large number of magnetic poles projecting toward the rotor from its inner circumferential surface, with an excitation coil being wound around each of those magnetic poles. That is, a minute step angle is obtained through such a construction of the motor itself, thus providing the requisite feeding precision for the optical part.

However, this construction of the tubular stepping motor cannot alter the basic requirement that the rotor be arranged inside the tubular stator, and thus allows no degree of freedom in terms of the stepping motor configuration. Hence, there is also no degree of freedom in designing the configuration of the lens driver equipped with the tubular stepping motor, making this lens driver (optical module) not suitable for applications where its configuration is to be changed in conformity with the confined installation space within the thin electronic apparatus in which it is to be installed.

### SUMMARY OF THE INVENTION

It is an object of the present invention to provide an optical module that is thin, allows freedom of design in configuration, and assures precision in the movement of optical parts while suppressing power loss.

To attain the above object, according to the present invention, an optical module includes: an optical part that is moved in a direction of an optical axis by moving means; a stepping motor including an excitation coil, a magnetic path forming member having a magnetic pole end, and a rotor; and a gear train that operatively couples power output from the stepping motor to the moving means.

Further, according to the present invention, the stepping motor includes: a coil block having the excitation coil; a yoke connected to this block at a yoke connecting portion thereof and whose magnetic path portion has a magnetic saturation portion with a narrow magnetic path width; and the rotor arranged in a rotor pass-through hole of the yoke, with the optical module being equipped with the optical part that is moved in the optical axis direction by the moving means, and the gear train operatively coupling the rotor and the moving means together.

In the present invention, by using the excitation coil generating a magnetic flux upon excitation and the rotor pass-through hole in which the rotor is arranged, the stepping motor equipped in the optical module rotates the rotor by guiding the magnetic flux generated by application of a drive pulse (excitation) to the rotor pass-through hole by way of the yoke. Hence, there are no particular restrictions on the positional relationship between the excitation coil and the rotor. The coil block can thus be placed arbitrarily with respect to the rotor. Therefore, the freedom of design in configuration is high, enabling a reduction in thickness.

Further, in a preferred aspect of the present invention, the axis of the rotor is arranged substantially parallel to the optical axis, and the rotor pass-through hole is provided at a position where it does not overlap the coil block.

According to the present invention, the gear train is capable of transmitting power solely through its motion within the plane perpendicular to the optical axis, whereby power loss is small, and further, the gear train can be arranged two-dimensionally, which contributes to a reduction in thickness. Moreover, the coil block and the rotor can be arranged two-dimensionally, thus enabling a further reduction in thickness.

In the present invention, the stepping motor mounted on one surface of the base plate includes: the coil block having the excitation coil arranged along the base plate; the yoke whose magnetic path portion excluding end portions connected to the coil block is provided so as to not overlap the coil block; and the rotor arranged in the rotor pass-through hole of the yoke. The optical part moved by the moving means and the stepping motor are arranged on the one surface such that they are positioned offset from each other along the base plate, with the optical axis of the optical part and the axis of the rotor being in parallel with each other. The gear train operatively coupling the rotor and the moving means together is arranged on the one surface.

Further, to attain the above object, according to the present invention, there is provided an optical module including a base plate, a stepping motor, an optical part, and a gear train. The stepping motor is mounted on one surface of the base plate and has a coil block, a yoke, and a rotor. The coil block has an iron core and an excitation coil and extends along an edge of the base plate, the iron core having a yoke connecting portion provided integrally at an end of a core portion, the excitation coil being wound around the core portion while forming a peripheral surface to be arranged along the base plate. A magnetic path portion of the yoke excluding end portions connected to the yoke connecting portion is provided so as not to overlap the coil block, and a rotor pass-through hole is provided in the magnetic path portion. The rotor is arranged in the rotor pass-through hole. The optical part is arranged on the one surface of the base plate so as to be movable by moving means, the optical part being offset with respect to the stepping motor along the base plate and having an optical axis extending parallel to the axis of the rotor. The gear train is provided on the one surface of the base plate and operatively couples the moving means and the rotor together.

According to the present invention as described in the foregoing, the stepping motor is not tubular and includes: the coil block having the excitation coil arranged along the base plate; the yoke whose magnetic path portion excluding the end portions connected to the coil block is provided so as not to overlap the coil block; and the rotor arranged in the rotor pass-through hole of the yoke. Accordingly, the stepping motor is formed in a flat-shaped configuration, and hence does not become a factor for increasing the thickness of the optical module. In addition, the present invention adopts a two-dimensional arrangement in which the stepping motor and the optical part that is moved by the moving means are arranged on one surface of the base plate so as to be positioned offset from each other along the base plate, with the gear train that operatively couples the rotor and the moving means together being provided on the one surface. Therefore, despite the fact that the optical axis of the optical part is in parallel with the rotor axis, the overall thickness of the optical module can be reduced as compared with an optical module having a tubular stepping motor that is vertically mounted.

Further, in the stepping motor equipped in this optical module, the excitation coil that generates a magnetic flux when excited and the rotor pass-through hole in which the rotor is arranged are offset from each other along one surface of the base plate, and the magnetic flux generated by application of a drive pulse (excitation) is guided to the rotor pass-through hole by way of the yoke to thereby rotate the rotor, whereby there are no particular restrictions on the positional relationship between the excitation coil and the rotor. The coil block can thus be positioned arbitrarily with respect to the rotor. Accordingly, when the coil block is to be arranged along the edge of the base plate, the configuration of the base plate may be varied as appropriate according to the arrangement of the coil block, making it possible to attain freedom of design in the configuration of the optical module.

In addition, as compared with the case of using a worm gear involving a large reduction ratio, the rotation of the rotor is reduced by using the gear train involving relatively little power loss due to sliding resistance before being imparted to the moving means for moving the optical part, whereby the optical part can be moved with good accuracy according to the reduction ratio of the gear train.

Further, in a preferred aspect of the present invention, the rotor and the gear train are arranged between the coil block and the optical part. This aspect of the invention advantageously involves a relatively small amount of the yoke material to be used, thus enabling a reduction in weight.

Further, in a preferred aspect of the present invention, respective gear shafts of the gear train are arranged within the projected area of the stepping motor. Further, in a preferred aspect of the present invention, the magnetic path portion has at least one shaft insertion portion consisting of one of a through-hole and a cutout, and at least one of gear shafts of the gear train is passed through the shaft insertion portion. Further, in a preferred aspect of the present invention, at least one of gear shafts of the gear train is passed through a gap between the magnetic path portion and the coil block.

According to those aspects of the present invention, at least part of gears fixed to the gear shafts arranged within the projected area mentioned above are arranged so as to overlap the stepping motor, whereby the space required for disposing the gears between the stepping motor and the optical part can be reduced, allowing a corresponding reduction in the size of the optical module.

Further, in a preferred aspect of the present invention, the gear train and the moving means are positioned opposite to each other with the yoke interposed therebetween.

According to the above aspect of the present invention, the moving means and the coil block can be arranged side by side two-dimensionally and need not to be overlapped with each other in the thickness direction, thus allowing a corresponding reduction in the thickness of the optical module. When assembling the moving means, the gear shafts connecting the gears and the moving means can be guided through the shaft insertion portion for assembly, thereby achieving an improvement in operability.

Further, in a preferred aspect of the present invention, the optical module further includes a detection portion for detecting a position of the optical part, the detecting portion being arranged at a position opposite to the moving means with respect to a line connecting the optical axis and an axis of the rotor. Further, the detection portion at least partially overlaps the projected area of the stepping motor.

According to the above aspects of the present invention, the provision of the detection portion enables enhanced performance in controlling the operation of the optical part. Further, the space for disposing the detection portion can be secured by using the dead space produced in the optical module accompanying installation of the other components, whereby the provision of the detection portion does not necessitate an increase in the overall size of the optical module.

Further, in a preferred aspect of the present invention, the coil block, the yoke, the rotor, the gear train, and a gear support that supports the gear train together with a base plate to which the stepping motor is fixed, can be assembled from one direction with respect to the base plate.

According to the above aspect of the present invention, there is no need to perform such a cumbersome operation as turning the whole assembly inside out during the assembly process, thus achieving enhanced ease of assembly.

Further, in a preferred aspect of the present invention, the optical module further includes a plurality of screw-fixing means for coupling the yoke and the coil block together and fixing the yoke and the coil block to the base plate. At least one of the plurality of screw-fixing means is screw-fastened in place without the intermediation of the gear support that supports, together with the base plate, respective gear shafts constituting the gear train. At least one of the other screw-fixing means is screw-fastened in place through the intermediation of the gear support.

According to the above aspect of the present invention, during assembly, the yoke can be fastened in place with the former screw-fixing means immediately after the yoke is placed on the base plate, whereby the subsequent incorporation of the gears and the gear support can be performed in a stable manner. Moreover, the gear support can be fixed in place with the latter screw-fixing means.

Further, in a preferred aspect of the present invention, a camera module includes the optical module described above, an image pickup element for converting an optical image into an electrical signal, and a control portion for controlling operation of the image pickup element.

According to the present invention, it is possible to provide an optical module that is thin, allows freedom of design in configuration, and assures the accuracy of movement of an optical part while suppressing power loss.

### BRIEF DESCRIPTION OF THE DRAWINGS

In the accompanying drawings:

FIG. 1 is a plan view showing a lens driver according to a first embodiment of the present invention with its cover and gear support removed;

FIG. 2 is a sectional view, taken along a line F2-F2 of FIG. 1, of the lens driver according to the first embodiment;

FIG. 3 is a sectional view, taken along a line F3-F3 of FIG. 1, of the lens driver according to the first embodiment;

FIG. 4 is a perspective view showing a stepping motor equipped in the lens driver according to the first embodiment;

FIG. 5 is a plan view showing a lens driver according to a second embodiment of the present invention with its cover and gear support removed;

FIG. 6 is a sectional view, taken along a line F6-F6 of FIG. 5, of the lens driver according to the second embodiment;

FIG. 7 is a plan view showing a lens driver according to a third embodiment of the present invention with its cover and gear support removed;

FIG. 8 is a plan view showing a lens driver according to a fourth embodiment of the present invention with its cover and gear support removed;

FIG. 9 is a plan view showing a lens driver according to the prior art with its cover and gear support removed;

FIG. 10 is a sectional view showing the lens driver according to the prior art;

FIG. 11 is a block diagram showing a camera module according to a fifth embodiment of the present invention;

FIG. 12 is a plan view, as seen from above, of the camera module according to the fifth embodiment of the present invention with its cover removed;

FIG. 13 is a sectional view, taken along a line F10-F10 of FIG. 12, of the camera module according to the fifth embodiment of the present invention;

FIG. 14 is a sectional view, taken along a line F11-F11 of FIG. 12, of the camera module according to the fifth embodiment of the present invention;

FIG. 15 is a plan view, as seen from above, of a camera module according to a sixth embodiment of the present invention with its cover removed; and

FIG. 16 is a plan view, as seen from above, of a camera module according to a seventh embodiment of the present invention with its cover removed.

### DESCRIPTION OF THE PREFERRED EMBODIMENTS

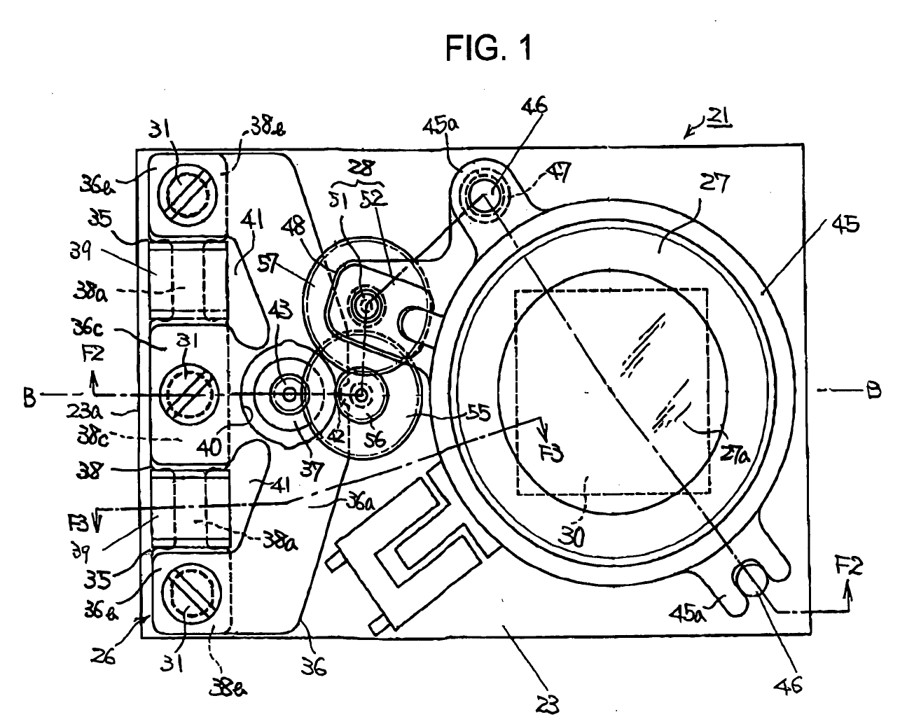

A first embodiment of the present invention is described with reference to FIGS. 1 through 4.

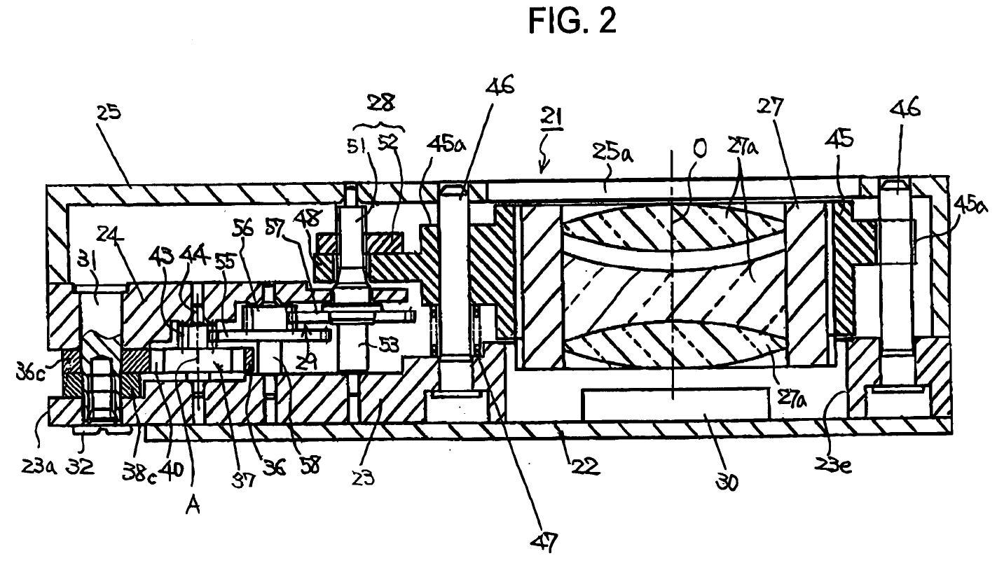

Referring to FIGS. 1 and 2, denoted by reference numeral 21 is an optical module, for example, a lens driver, which is mounted to a thin electronic apparatus such as a card-type digital camera or a camera-equipped portable telephone. The lens driver 21 includes a circuit board 22, a base plate 23, a gear support 24, a cover 25, a stepping motor 26, an optical part such as a lens barrel 27, moving means 28, and a reduction gear train 29 serving as a gear train.

The circuit board 22 is a hard board with an image pickup element 30 such as a CCD or a CMOS mounted on one surface thereof. A base plate 23 is fitted onto the one surface of the circuit board 22. The base plate 23 is, for example, rectangular in shape, and has in its one longitudinal end portion a hole 23e receiving the image pickup element 30 and allowing the placement of the lens barrel 27. The gear support 24 is arranged so as to be opposed to, and spaced at a predetermined distance from, the other longitudinal end portion of the base plate 23. The cover 25 is attached between the gear support 24 and the one longitudinal end portion of the base plate 23. The cover 25 has a window hole 25a opposed to the incidence surface of the lend barrel 27.

The gear support 24 also serves as a member sandwiching the stepping motor 26 between it and the base plate 23 for fixation. The gear support 24 is fixed in place through the intermediation of a plurality of, for example, three mounting shafts 31 each mounted to the base plate 23 with a screw 32 fastened onto the base plate 23 from the back side thereof.

The stepping motor 26 is a bipolar motor with a step angle of 180 degrees, for example. As shown in FIGS. 1 and 4, the stepping motor 26 includes coil blocks 35, a yoke 36, and a rotor 37. The coil blocks 35 and the yoke 36 form a stator.

Each coil block 35 has an iron core 38 and an excitation coil 39. The iron core 38 has yoke connecting portions 38b and 39c integrally provided at opposite longitudinal ends of a core portion 38a (see FIGS. 1 and 4). In a preferred example, a pair of the coil blocks 35 are provided such that the rotor 37 is rotated at the same RPM during the forward and reverse rotations thereof. Since in this embodiment, in particular, one common yoke connecting portion 38c is shared between those coil blocks 35 to allow integral construction thereof, the yoke connecting portion 38b is provided on either side of the yoke connecting portion 38c through the intermediation of the core portion 38a. The excitation coil 39 is wound around each of the core portions 38a.

The yoke 36 guiding the magnetic flux generated by excitation of the excitation coil 39 has a planar shape and includes end portions 36b and 36c respectively connected to the yoke connecting portions 38b and 38c. A pair of the end portions 36b are each connected to the yoke connecting portion 38b, and the other one end portion 36c situated between the pair of end portions 36b is connected to the yoke connecting portion 38c. A magnetic path portion 36a of the yoke 36 excluding the end portions 36b and 36c protrudes to the side of the coil blocks 35 without overlapping the coil blocks 35. A rotor pass-through hole 40 is formed in the magnetic path portion 36a.

A gap 41 is formed between the magnetic path portion 36a and each coil block 35. At least a part of the side surface of the excitation coil 39 faces the gap 41. Referring to FIGS. 1 and 4, reference numeral 42 denotes a recess in the magnetic path portion 36a which is provided in the vicinity of the rotor pass-through hole 40. The space between the recess 42 and the rotor pass-through hole 40, and the space between the gap 41 and the rotor pass-through hole 40 each have an extremely small sectional area of the magnetic path so that magnetic saturation takes place extremely easily. Accordingly, the inner peripheral surface of the rotor pass-through hole 40 is substantially partitioned off by the above-mentioned portions each having the extremely small magnetic path sectional area. Each of those partitioned regions functions as a magnetic pole end, with an S-pole or an N-pole appearing at the magnetic pole end each time a drive pulse is applied to the excitation coil 39. There are provided three magnetic pole ends in this example, with the magnetic pole ends and end portions of the excitation coil being magnetically connected with each other to allow propagation of the magnetic flux generated in the excitation coil to each magnetic pole end. Of the three magnetic pole ends, one is magnetically connected to end portions of two excitation coils.

The rotor 37 is arranged in the rotor pass-through hole 40. The outer peripheral portion of the rotor 37 is magnetized in different polarities differing for each of predetermined circumferentially adjacent regions. Accordingly, each time a drive pulse is applied to its excitation coil 39 through a motor driver (not shown), the stepping motor 26 is rotated at a step angle of 180 degrees through the magnetic action between the magnetic pole ends and the magnetic poles of the rotor 37. A drive gear 43 is coupled to or formed integrally with the rotor 37. The opposite ends of a rotary shaft 44 of the rotor 37 are rotatably supported to the base plate 23 and the gear support 24, respectively.

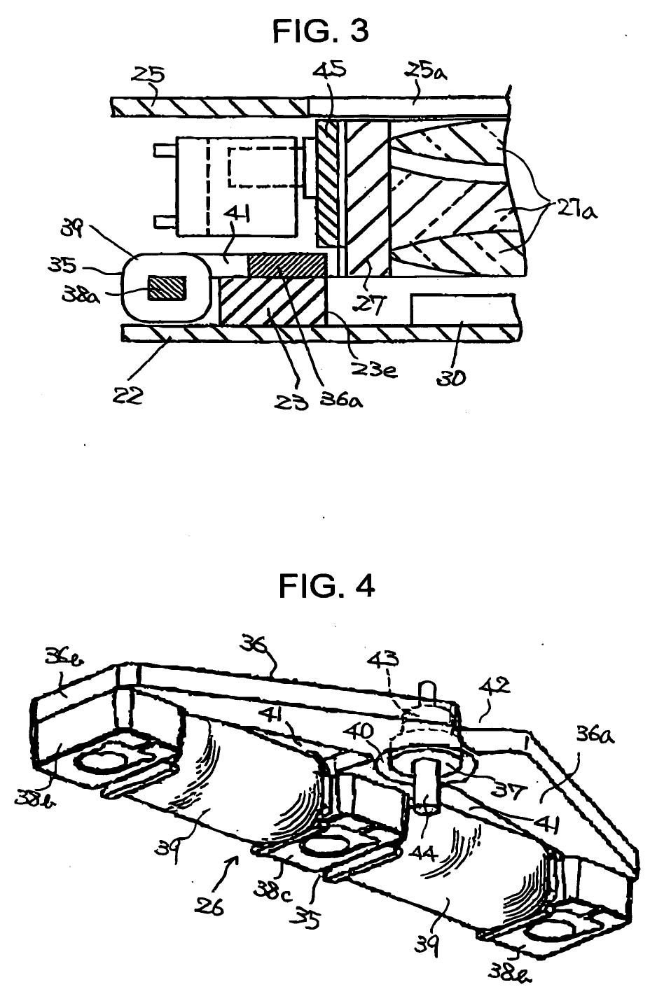

The stepping motor 26 is arranged along an edge of the base plate 23. Specifically, as shown in FIG. 1, the stepping motor 26 is arranged such that the coil blocks 35 extend along an edge 23a in the other longitudinal end side portion of the base plate 23. The stepping motor 26 thus arranged is fixed to the base plate 23 through the intermediation of the mounting shafts 31 and the screws 32. In this case; each mounting shaft 31 is passed through the yoke connecting portion 38b and the end portion 36b of the yoke 36 which is connected to the yoke connecting portion 38b, or through the yoke connecting portion 38c and the end portion 36c of the yoke 36 which is connected to the yoke connecting portion 38c, and the screw 32 is fastened onto the mounting shaft 31, thereby sandwiching the stepping motor 26 between the base plate 23 and the gear support 24 for fixation. As shown in FIG. 3, through this fixation, the peripheral surface of the excitation coil 39 is arranged along the base plate 23, and the magnetic path portion 36a is arranged along one surface of the base plate 23.

The lens barrel 27 has a plurality of lens 27a accommodated in the inside thereof. A lens barrel holder 45 is screw-mounted onto the outer periphery of the lens barrel 27. A plurality of, for example, a pair of sliding portions 45a protrude from the outer periphery of the lens barrel holder 45 preferably in correspondence with a substantially radial direction. Each of the sliding portions 45a has a shaft sliding element consisting of a through hole, a recess groove, or the like. A plurality of guide shafts 46 are mounted in the periphery of the lens barrel 27 so as to extend between the base plate 23 and the cover 25. Each of the guide shafts 46 is passed through the shaft sliding element described above. As a result, the lens barrel 27 is opposed to the image pickup element 30 and supported so as to be movable along the plurality of guide shafts 46 toward and away from the image pickup element 36. This movement effects the focusing operation of the lens barrel 27 with respect to the image pickup element 30.

The lens barrel 27 supported as described above is arranged offset to one longitudinal end side of the base plate 23 with respect to the stepping motor 26, with its optical axis O being parallel to an axis A of the rotor 37. A coil spring 47 is wound around one guide shaft, for example, the guide shaft 46 situated close to the stepping motor 26. The coil spring 47 is sandwiched between one sliding portion 45a through which the one guide shaft 46 is passed, and the base plate 23, thereby urging the lens barrel 27 away from the image pickup element 30 through the intermediation of the lens barrel holder 45.

An outwardly protruding portion 48 protrudes from the outer periphery of the lens barrel holder 45. The outwardly protruding portion 48 protrudes on the stepping motor 26 side, for example, and extends integrally continuous to the one sliding portion 45a. It is to be noted that the outwardly protruding portion 48 and the one sliding portion 45a may not be continuous to each other.

The moving means 28 is equipped with a feed screw 51 and a nut member 52. As shown in FIG. 2, the feed screw 51 constitutes a part of a gear shaft 53. The gear shaft 53 extends through the gear support 24 and the outwardly protruding portion 48 opposed in close proximity to the gear support 24, with the opposite ends of the gear shaft 53 being respectively rotatably supported to the base plate 23 and the cover 25. The nut member 52 is fixed to the outwardly protruding portion 48, with the feed screw 51 being passed through the nut member 52 in meshing engagement therewith. Accordingly, as the gear shaft 53 is rotated, this rotation is converted into the motion for moving the lens barrel holder 45 in the axial direction of the feed screw 51 by the moving means 28. The lens barrel 27 is thus moved along its optical axis O.

The moving means 28 and the rotor 37 are connected to each other through the intermediation of the reduction gear train 29 arranged on one surface side of the base plate 23. As shown in FIGS. 1 and 2, the reduction gear train 29 includes a plurality of, for example, first to third reduction gears 55 to 57 each consisting of a spur gear. The first reduction gear 55 is in mesh with the drive gear 43 of the rotor 37, and the second reduction gear 56 rotated integrally with the first reduction gear 55 is in mesh with the third reduction gear 57. Further, the third reduction gear 57 is mounted to the gear shaft 53. The opposite ends of the gear shaft 58 that supports the first reduction gear 55 and the second reduction gear 56 are rotatably supported to the base plate 23 and the gear support 24, respectively. Accordingly, as the stepping motor 26 is driven and its rotor 37 is rotated, this rotation is subjected to reduction by the reduction gear train 29 before being imparted to the moving means 28.

As shown in FIG. 1, in the lens driver 21 having the stepping motor 26, the lens barrel 27, the moving means 28, and the reduction gear train 29 thus deployed and arranged on one surface of the base plate 23 as described above, the rotor 37 and the reduction gear train 29 are arranged between the coil blocks 35 of the stepping motor 26 and the lens barrel 27. Accordingly, the magnetic path portion 36a of the yoke 36 does not have such a size as to surround substantially the entire lens barrel 27, and the magnetic path portion 36a is arranged in a manner in conformity with the space between the coil blocks 35 and the lens barrel 27, whereby a relatively small amount of the magnetic material forming the yoke 36 is used, thus enabling lightweight construction and cost reduction.

As shown in FIG. 1, the stepping motor 26 is arranged in line symmetry with respect to the line (line B-B) connecting between the center of the lens barrel 27 and the center of the rotor 37. In addition to improving the weight balance of the lens driver 21, this symmetrical arrangement is preferred because it allows the respective lengths of the pair of magnetic paths, each extending from the yoke connecting portion 38b to the rotor pass-through hole 40, to be the same, thereby achieving an improved magnetic balance.

The stepping motor 26 used in the lens driver 21 constructed as described above is not tubular. Since the stepping motor 26 includes the coil blocks 35 each having the excitation coil 39 arranged along one surface of the base plate 23, the yoke 36 whose magnetic path portion 36a excluding the end portions 36b and 36c connected to the coil blocks 35 is provided along the base plate 23 without overlapping the coil blocks 35, and the rotor 37 arranged in the rotor pass-through hole 40 of the yoke 36, the stepping motor 26 can be formed in a flat-shaped configuration. Accordingly, the stepping motor 26 does not constitute a factor for increasing the thickness of the lens driver 21. Moreover, the excitation coil 39 of the stepping motor 26 is mounted horizontally with its peripheral surface extending along the base plate 23, so that, even when the winding length of the excitation coil 39 with respect to the core portion 38a is increased for increased magnetic flux generation, this does not constitute a factor for increasing the thickness of the stepping motor 26 and therefore the thickness of the lens driver 21.

In addition, the stepping motor 26 and the lens barrel 27 that is moved by the moving means 28 driven by the power of the motor 26 are provided on one surface of the base plate 23 at positions offset from each other along the longitudinal direction of the base plate 23, with the reduction gear train 29 that operatively couples the rotor 37 and the moving means 28 together being provided between the stepping motor 26 and the lens barrel 27 on the one surface, thus realizing two-dimensional arrangement of those components.

Therefore, despite the fact that the optical axis O of the lens barrel 27 and the axis A of the rotor 37 are in parallel with each other, the thickness of the lens driver 21 as a whole can be reduced as compared with the case of a lens driver whose tubular stepping motor is vertically mounted.

Further, in the stepping motor 26, the excitation coils 39 which generate magnetic fluxes when applied with a drive pulse, and the rotor pass-through hole 40 in which the rotor 37 is arranged are arranged offset from each other along one surface of the base plate 23, with the generated magnetic fluxes being guided to the rotor pass-through hole 40 by way of the magnetic path portion 36a of the yoke 36 to thereby rotate the rotor 37. Hence, there are no particular restrictions on the positional relationship between the excitation coils 39 and the rotor 37.

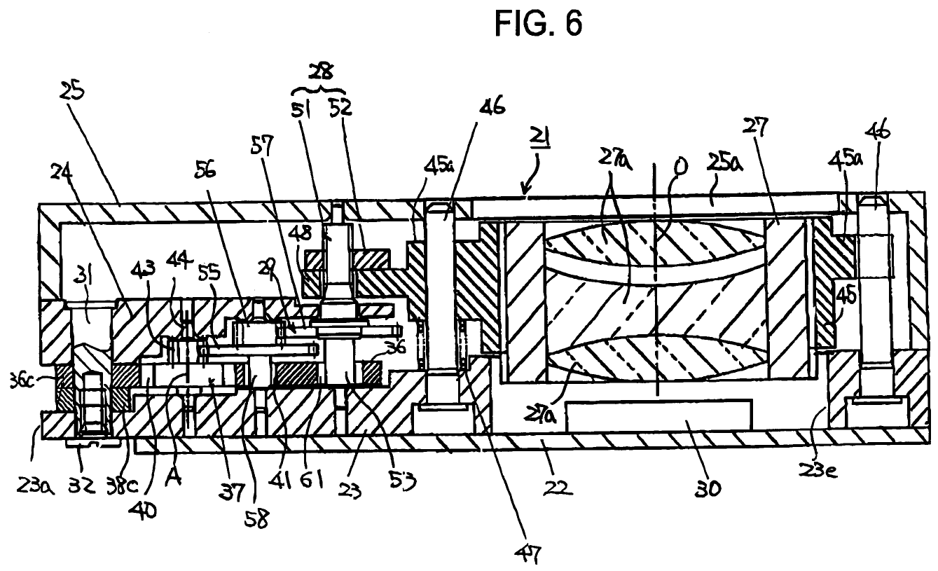

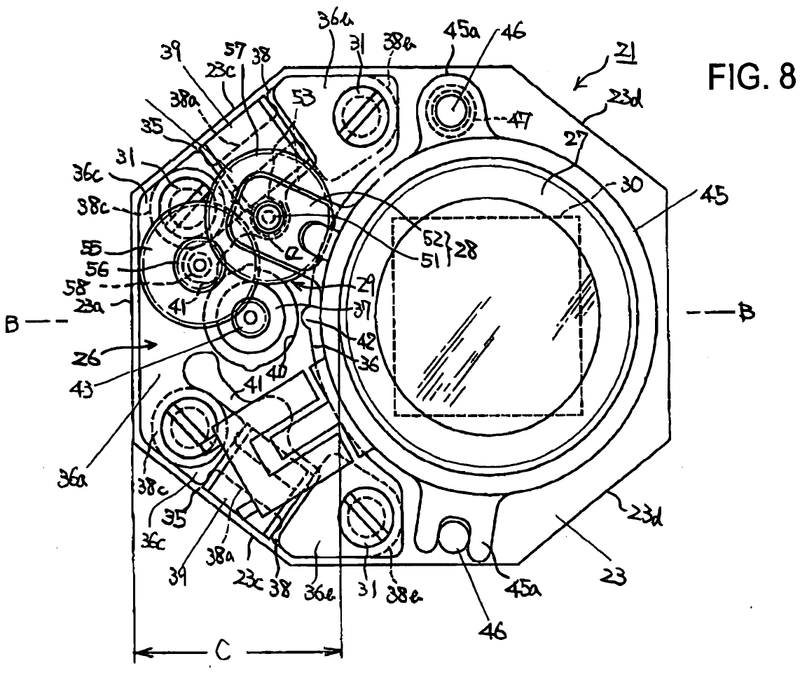

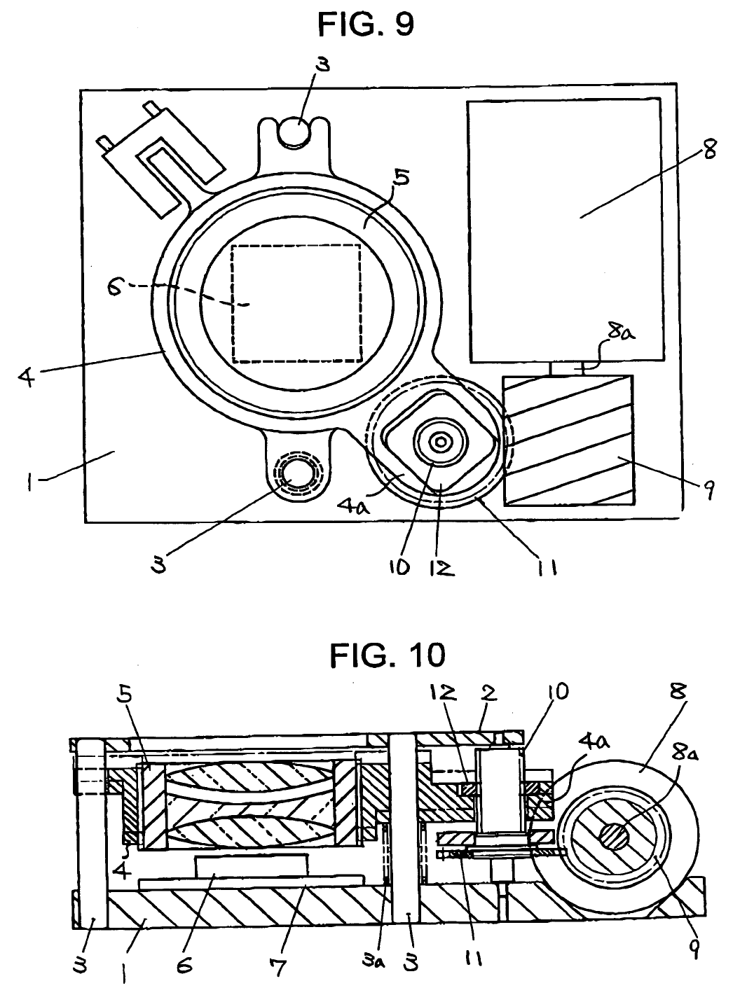

Therefore, the stepping motor 26 can function as a motor even when the coil blocks 35 are placed arbitrarily with respect to the rotor 37, and there are no restrictions on the placement of the rotor 37 and the excitation coils 39. This feature becomes apparent in comparison with the placements according to second through fourth embodiments respectively described later with reference to FIGS. 6 through 8. Accordingly, when the coil blocks 35 are to be arranged along an arbitrary edge of the base plate 23, the configuration of the base plate 23 can be changed into one in conformity with the placement of the excitation coils 39 thereof (It is to be noted that a modified configuration of the base plate 23 can be exemplified by that of the fourth embodiment described later with reference to FIG. 8).

That is, the configuration of the base plate 23 of the lens driver 21 can be altered as described above according to the design of the coil blocks 35, thus permitting freedom of design in the configuration of the lens driver 21.

Further, as aforementioned, the lens driver 21 of the above construction uses the reduction gear train 29 consisting of spur gears to transmit rotation of the rotor 37 to the moving means 28 for moving the lens barrel 27. Since the reduction gear train 29 does not obtain a large reduction ratio through one gear stage as is the case with a worm gear, it involves relatively little power loss due to sliding resistance and accordingly reduced electric power consumption by the stepping motor 26. Moreover, despite the step angle of 180 degrees, the feed screw 51 of the moving means 28 is rotated at reduced speed in accordance with the reduction ratio of the reduction gear train 29, whereby it is possible to effect the focusing or zooming operation while moving the lens barrel 27 with a high precision on the order of 10 microns through the intermediation of the nut member 52.

Further, two excitation coils and three magnetic pole ends are provided, whereby the magnetic pole to be generated in each magnetic pole end can be selected through selection of a drive pulse to be applied to each excitation coil, and by optimizing this selection, it is possible to eliminate the dead point during both forward and reverse rotations of the rotor. Accordingly, the rotor can be rotated in both forward and reverse motions stably and with equivalent characteristics. As a result, it is possible to realize an optical module providing high reliability of operation and high precision.

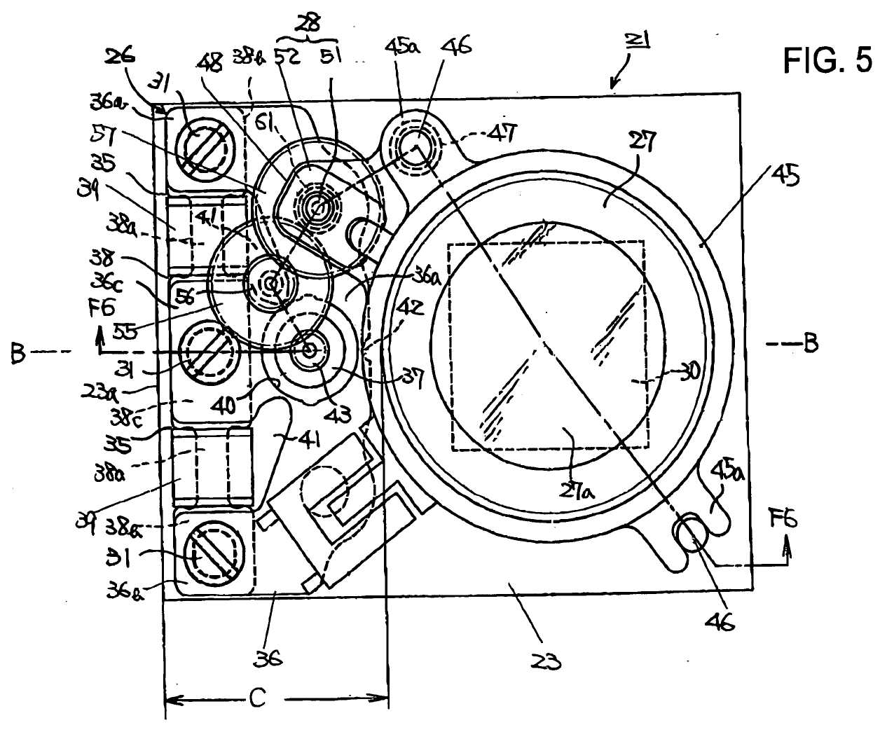

FIGS. 5 and 6 illustrate a second embodiment of the present invention. Since this embodiment is basically the same as the first embodiment, the structures that are the same as those of the first embodiment are denoted by the same symbols and their description is omitted, and differences from the first embodiment are described below.

According to the second embodiment, the gear shafts 53 and 58 of the reduction gear train 29 are arranged within the projected area of the stepping motor 26. To realize this placement, a through-hole 61 is provided in the magnetic path portion 36a of the yoke 36. The gear shaft 53 whose opposite ends are rotatably supported to the base plate 23 and the gear support 24 is passed through the pass-hole 61. The gear shaft 58, having its opposite ends rotatably supported to the base plate 23 and the gear support 24, is passed through the gap 41 between each coil block 35 and the magnetic path portion 36a. The reduction gear 55 thus overlaps the coil 39. Note that, otherwise, this embodiment is of the same construction as the first embodiment.

Therefore, the second embodiment provides the same operational effects as those of the first embodiment, thus attaining the object of the present invention. In addition, the gear shafts 53 and 58 are arranged within the projected area of the stepping motor 26, whereby, as shown in FIG. 5, the reduction gears 55 to 57 fixed to the gear shafts 53 and 58 can be placed so as to substantially overlap the stepping motor 26. Accordingly, the space required for arranging the reduction gears 55 to 57 between the stepping motor 26 and the lens barrel holder 45 is reduced, whereby the distance between the edge 23a of the base plate 23 and the lens barrel 27, which is indicated by symbol C in FIG. 5, is shortened, allowing a corresponding reduction in the size of the lens driver 21.

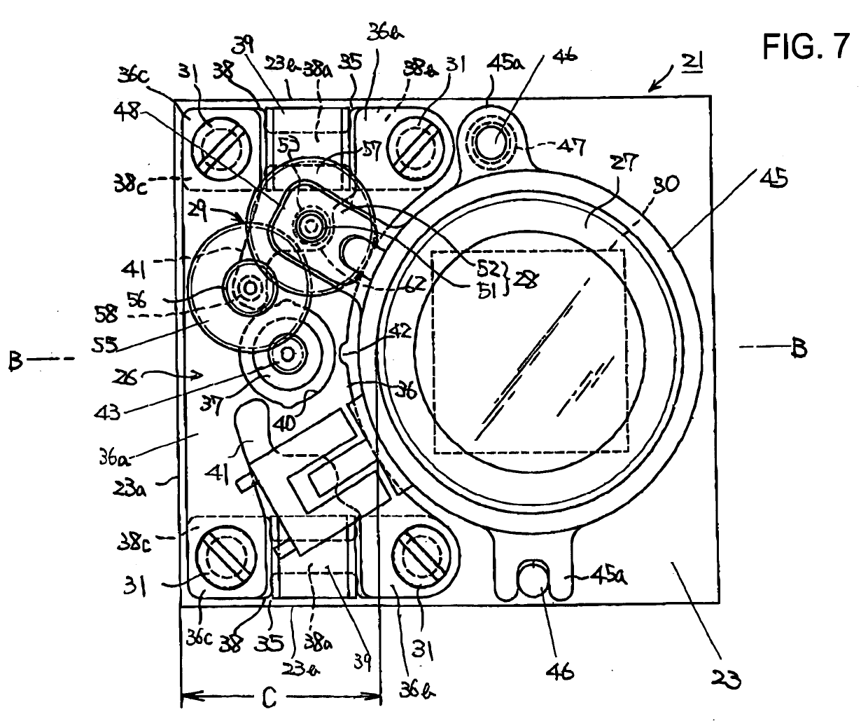

FIG. 7 shows a third embodiment of the present invention. Since this embodiment is basically the same as the first embodiment, the structures that are the same as those of the first embodiment are denoted by the same symbols and their description is omitted, and differences from the first embodiment are described below.

According to the third embodiment, the stepping motor 26 includes a pair of the coil blocks 35. Each of the coil blocks 35 includes the iron core 38 having the yoke connecting portions 38b and 38c integrally provided to the opposite longitudinal ends of the core portion 38a, and the excitation coil 39 wound around the core portion 38a. The coil blocks 35 are arranged along the edge 23b constituting the long side of the rectangular base plate 23.

The yoke 36 has, in addition to the magnetic path portion 36a, a pair of the end portions 36b and a pair of the end portions 36c. The pair of end portions 36b are each connected to the yoke connecting portion 38b of each of the two coil blocks 35, and the pair of the other end portions 36c are each connected to the other yoke connecting portion 38c of each of the two coil blocks 35. The section of the magnetic path portion 36a which connects the pair of end portions 36c with each other at the shortest distance is arranged along the edge 23a constituting the short side of the base plate 23. The section of the magnetic path portion 36a which connects the pair of end portions 36b with each other has an arcuate edge and is placed such that this edge extends along the outer periphery of the lens barrel holder 45.

The outwardly protruding portion 48 of the lens barrel holder 45 is provided so as not to extend continuously to the sliding portion 45a situated close thereto. Further, the gear shafts 53 and 58 of the reduction gear train 29 are arranged within the projected area of the stepping motor 26. To realize this placement, the gear shafts 53 and 58, having their opposite ends rotatably supported to the base plate 23 and the gear support 24, are passed through the gap 41 between each coil block 35 and the magnetic path portion 36a. Indicated by reference numeral 62 in FIG. 7 is a cutout in the magnetic path portion 36a which is open to the gap 41. The gear shaft 53 is passed through the cutout 62 to thereby prevent interference between the gear shaft 53 and the magnetic path portion 36a. Note that, otherwise, this embodiment is of the same construction as the first embodiment.

Therefore, the third embodiment provides the same operational effects as those of the first embodiment, thus attaining the object of the present invention. In addition, the gear shafts 53 and 58 are arranged within the projected area of the stepping motor 26, whereby, as shown in FIG. 7, all of the reduction gears 55 to 57 fixed to the gear shafts 53 and 58 can be placed so as to substantially overlap the stepping motor 26. Accordingly, the space required for arranging the reduction gears 55 to 57 between the stepping motor 26 and the lens barrel holder 45 is reduced, whereby the distance between the edge 23a of the base plate 23 and the lens barrel 27, which is indicated by symbol C in FIG. 7, is shortened, allowing a corresponding reduction in the size of the lens driver 21. Moreover, according to the third embodiment, the coil blocks 35 are not arranged along the edge 23a of the base plate 23, whereby the rotor 37 can be placed closer to the edge 23a. The above-mentioned distance C is thus further shortened, facilitating the miniaturization of the lens driver 21.

FIG. 8 shows a fourth embodiment of the present invention. Since this embodiment is basically the same as the first embodiment, the structures that are the same as those of the first embodiment are denoted by the same symbols and their description is omitted, and differences from the first embodiment are described below.

According to the fourth embodiment, the base plate 23 has an octagonal shape with diagonal edges 23c and 23d. The stepping motor 26 includes a pair of the coil blocks 35. Each of the coil blocks 35 includes the iron core 38 having the yoke connecting portions 38b and 38c integrally provided at the opposite longitudinal ends of the core portion 38a, and the excitation coil 39 wound around the core portion 38a. The two coil blocks 35 are each arranged along the diagonal edge 23c of the base plate 23.

The magnetic path portion 36a of the yoke 36 has a pair of the end portions 36b and a pair of the end portions 36c. The pair of end portions 36b are each connected to the yoke connecting portion 38b of each of the two coil blocks 35, and the pair of the other end portions 36c are each connected to the other yoke connecting portion 38c of each of the two coil blocks 35. The section of the magnetic path portion 36a which connects the pair of end portions 36c with each other at the shortest distance is arranged along the edge 23a constituting the short side of the base plate 23. The section of the magnetic path portion 36a which connects the pair of end portions 36b with each other has an arcuate edge and is placed such that this edge extends along the outer periphery of the lens barrel holder 45.

The outwardly protruding portion 48 of the lens barrel holder 45 is provided so as not to extend continuously to the sliding portion 45a situated close thereto. Further, the gear shafts 53 and 58 of the reduction gear train 29 are arranged within the projected area of the stepping motor 26. To realize this placement, the gear shafts 53 and 58, having their opposite ends rotatably supported to the base plate 23 and the gear support 24, are passed through the gap 41 between each coil block 35 and the magnetic path portion 36a. Indicated by reference numeral 62 in FIG. 8 is a cutout in the magnetic path portion 36a which is open to the gap 41. The gear shaft 53 is passed through the cutout 62 to thereby prevent interference between the gear shaft 53 and the magnetic path portion 36a. Note that, otherwise, this embodiment is of the same construction as the first embodiment.

Therefore, the fourth embodiment provides the same operational effects as those of the first embodiment, thus attaining the object of the present invention. In addition, the gear shafts 53 and 58 are arranged within the projected area of the stepping motor 26, whereby, as shown in FIG. 8, all of the reduction gears 55 to 57 fixed to the gear shafts 53 and 58 can be placed so as to substantially overlap the stepping motor 26. Accordingly, the space required for arranging the reduction gears 55 to 57 between the stepping motor 26 and the lens barrel holder 45 is reduced, whereby the distance between the edge 23a of the base plate 23 and the lens barrel 27, which is indicated by symbol C in FIG. 8, is shortened, allowing a corresponding reduction in the size of the lens driver 21. Moreover, according to the fourth embodiment, the coil blocks 35 are not arranged along the edge 23a of the base plate 23, allowing the rotor 37 to be placed closer to the edge 23a. The above-mentioned distance C is thus further shortened, facilitating the miniaturization of the lens driver 21.

Further, according to the fourth embodiment, the pair of coil blocks 35 of the stepping motor 26 are placed in a V-shaped formation, with the pair of diagonal edges 23c extending along the coil blocks 35 being provided in the base plate 23 in correspondence with the V-shaped formation. This arrangement advantageously enables a reduction in the size of the base plate 23 and, by extension, a reduction in the space required for the placement of the lens driver 21. As described above, the lens driver 21 is suitable for applications where its configuration is to be changed in conformity with the confined installation space within a thin electronic apparatus to which the lens driver 21 is to be installed. In addition, according to the fourth embodiment, the pair of guide shafts 46 are placed in the vicinity of the yoke connecting portions 38c, thus allowing the pair of the other diagonal edges 23d to be provided in the base plate 23. Also in this respect, the fourth embodiment advantageously enables a reduction in the size of the base plate 23 and also a reduction in the space required for the placement of the lens driver 21.

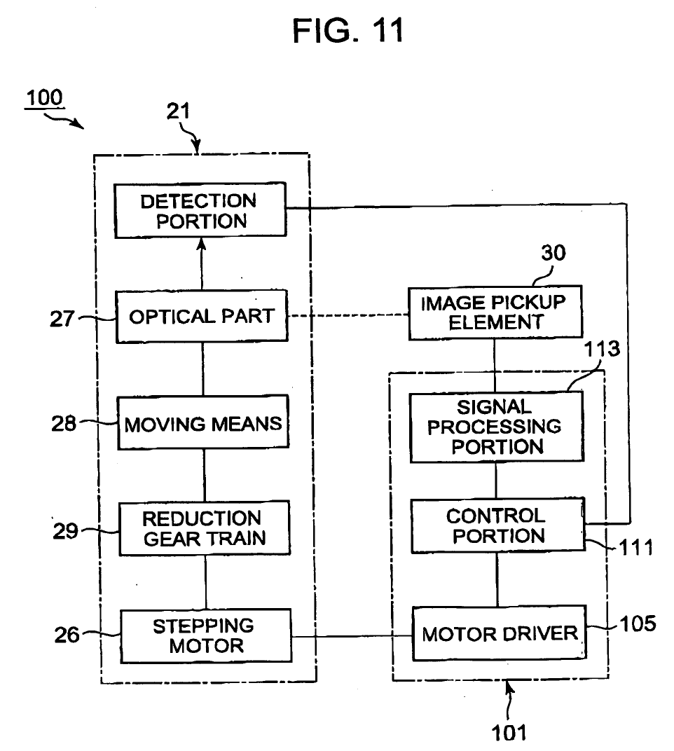

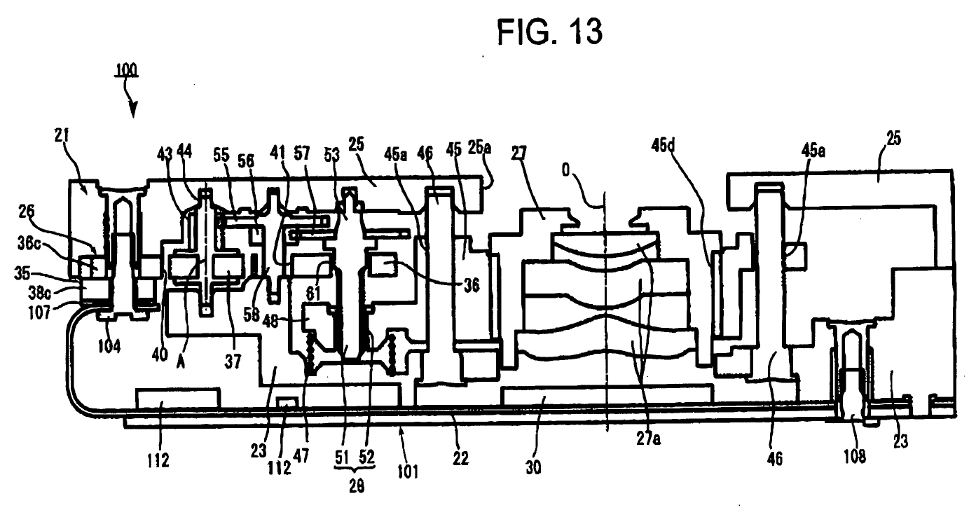

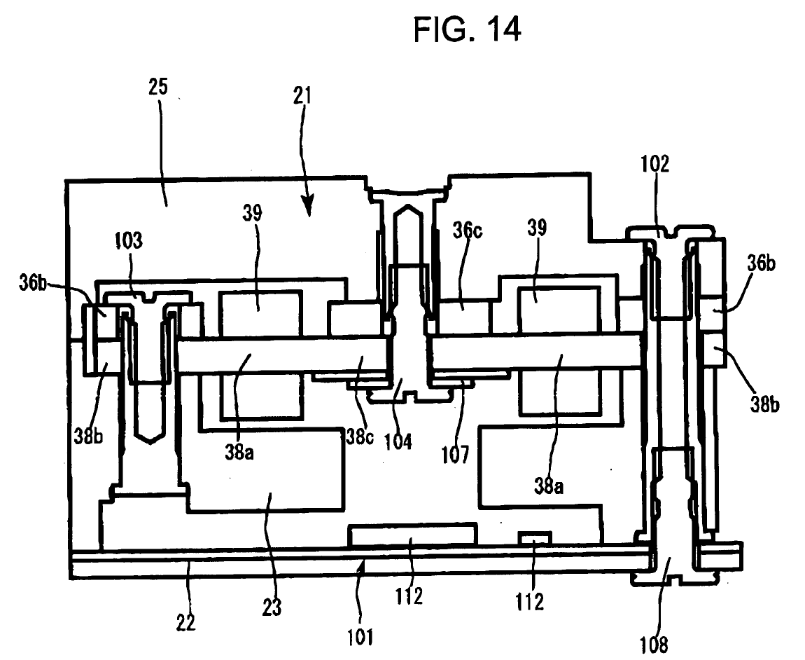

Now, a fifth embodiment of the present invention is described with reference to FIGS. 11 to 14, Since the optical module portion of this embodiment is basically the same as that of the first embodiment, the structures that are the same as those of the first embodiment are denoted by the same symbols and their description is omitted, and differences from the first embodiment are described below.

A camera module 100 is composed of the optical module 21, a circuit block 101, and the image pickup element 30. The circuit block 101 includes a control portion 111, a motor driver 105, a signal processing portion 113, etc. The control portion 111 has a CPU, a memory, etc., and performs overall control of the optical module 21 of the camera module 110, including control of the operation of the image pickup element 30. The motor driver 105 applies a requisite number of drive pulses to the stepping motor 26. The signal processing portion 113 performs processing on an image pickup signal output from the image pickup element 30 before supplying it to the control portion 111.

All or part of the electronic parts constituting the circuit block 101 and the image pickup element 30 are mounted on the circuit board 22 and connected to a circuit pattern provided on the circuit board 22.

The stepping motor 26 of the optical module 21 is arranged on the base plate 23, on which the coil blocks 35, the yoke 36, and the cover 25 that also functions as a gear support in this example are placed in the stated order from the bottom and fixed in place with a screw 102. Each coil block 35 is equipped with a terminal board 107 for inputting a signal from the motor driver 105 to the coil 39, with the circuit board 22 equipped with a signal terminal from the motor driver 105 being brought into press contact with the terminal board 107 with a screw 104. Accordingly, a signal can be sent from the circuit board 22 to the stepping motor 26.

A screw 108 fastens the circuit board 22 onto the base plate 23. Accordingly, mechanical connection can be established between the optical module 21 and the circuit block 101. Further, a screw 103 screws the stepping motor 26 onto the base plate 23 without the intermediation of the gear support 24.

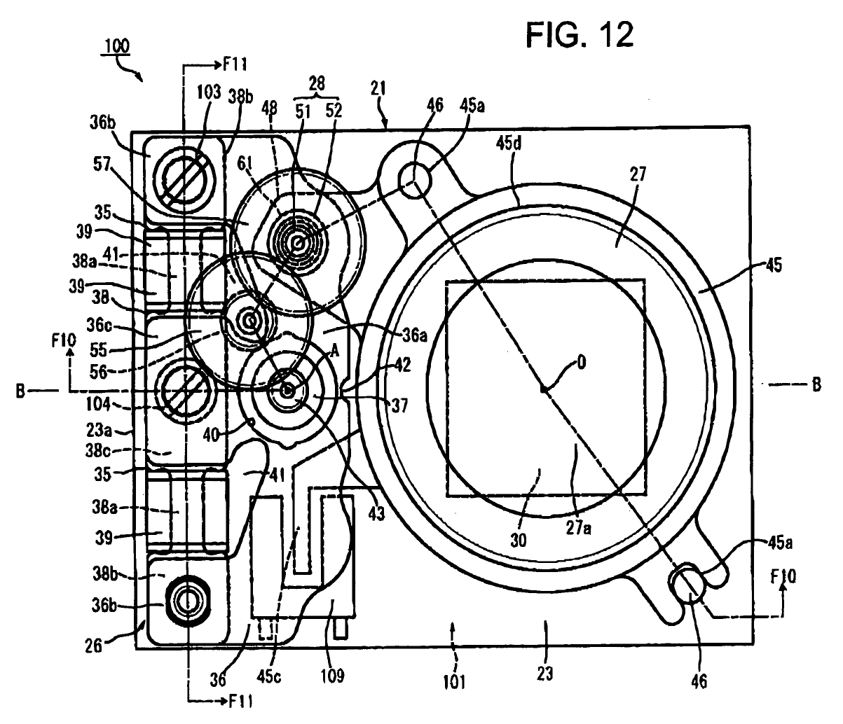

The moving means 28 is arranged between the yoke 36 and the base plate 23, and the reduction gear train 29 is arranged at a position opposed to the moving means 28 with the yoke 36 therebetween. That is, the coil blocks 35 and the moving means 28 are arranged side by side under the yoke 36. Incidentally, in the first embodiment, the elements constituting the thickness of the optical module are the base plate 23, the coil blocks 35, the yoke 36, the reduction gear train 29, the gear support 24, the moving means 28, and the cover 25. In the fifth embodiment, in contrast, the base plate 23, the moving means 28, and the coil blocks 35 are arranged at the same height at least partially with respect to the thickness direction, and the cover 25 also functions as the gear support, whereby either of the moving means 28 or the coil blocks 35 (the moving means 28 in FIG. 12), the yoke 36, the reduction gear train 29, and the cover 25 are such elements constituting the optical module thickness. Therefore, as compared with the first embodiment, the thickness of the optical module can be reduced by an amount corresponding to the thickness of either of the moving means 28 or the coil blocks 35 (the coil blocks 35 in FIG. 12) and the thickness of the gear support 24.

Therefore, the above-described construction is further suited for achieving a reduction in thickness. Further, the gear support 24 and the cover 25 are integrated together, thus achieving a reduction in cost.

While it is also possible to provide the coil blocks 35 and the reduction gear train 29 on the same side with respect to the yoke 36, when passing the gear shaft 53 through the cutout 62, for example, there is a fear that the coil blocks 35 and the reduction gear 55 may interfere with each other. To avoid this, the height position of the reduction gear 55 must be spaced at a large distance from that of the yoke 36, resulting in the increased thickness of the optical module 21. For this reason, the coil blocks 35 are arranged on the moving means 28 side.

As in the second embodiment, the gear shafts 53 and 58 of the reduction gear train 29 are arranged within the projected area of the stepping motor 26. The term “projected area” as used herein refers to the area enclosed by the outermost curve produced by projecting the stepping motor 26 onto an arbitrary plane perpendicular to the optical axis direction.

As a result, the space required for arranging the reduction gears 55 to 57 between the stepping motor 26 and the lens barrel holder 45 is reduced, whereby the distance between the edge 23a of the base plate 23 and the lens barrel 27 is shortened, allowing a corresponding reduction in the size of the lens driver 21.

Further, the optical module 21 includes a sensor 109 serving as a detection portion for detecting some quantity relating to motion of the optical part 27, for example, for detecting on which side of a predetermined reference (origin) position the optical part is located. Used as the sensor 109 is a photo interrupter or the like that optically detects a protruding portion 45c integrally provided in the lens barrel holder 45 in a non-contact manner. The sensor 109 and the protruding portion 45c constitute origin detecting means for detecting, each time an operation such as focus adjustment is performed, the origin position serving as a reference for this operation, with the focus adjustment operation or the like being effected with the thus detected origin taken as the reference position. This increases the reproducibility of the operation of the optical part 27. It is to be noted that a part of the circuit board 22 is bent for electrical connection with the sensor 109 (not shown). Signals are thus passed between the sensor 109 and the control portion 111 through the intermediation of the circuit board 22.

In the fifth embodiment, the sensor 109 is fixed onto the base plate 23. With respect to the thickness direction, the sensor 109 is positioned on the side opposite to the reduction gear train 29 with the yoke 36 therebetween; in plan view, the sensor 109 is arranged at a position (the position opposed to the moving means 28 with respect to the line B-B) where it overlaps the yoke 36 but does not overlap the reduction gear train 29 and is arranged side by side with the moving means 28.

A part of an electronic part 112 constituting the circuit block 101 can be arranged on the circuit board 22 by using, for example, a gap provided between the base plate 23 and the circuit board 22.

The above-described arrangement of the respective components allows the optical module 21 and therefore the camera module 100 to be reduced in planer size and also reduced in thickness.

In particular, the important elements in determining the planar surface area of the optical module 21, namely the optical system elements including the lens barrel 27, a lens barrel holder 45d holding the lens barrel 27, the image pickup element 30, etc., and the driver system elements including the stepping motor 26, the reduction gear train 29, the moving means 28, the sensor 109, etc., are arranged offset side by side as seen in plan view; as for the construction of the driver system elements with respect to the optical axis direction, the coil blocks 35, the rotor 37, the reduction gear train 29, the moving means 28, the sensor 109, and the outwardly protruding portion 48 and protruding portion 45c of the lens barrel holder 45 are arranged so as to overlap in plan view the yoke 36 requiring a large planar surface area and to have a combined thickness less than the combined thickness of the optical system elements. Furthermore, the coil blocks 35 and the sensor 109 are assembled on the same side as the moving means 28 located on the side opposite to the reduction gear train 29 with the yoke 36 therebetween in the optical axis O direction. Therefore, the moving means 28 having a relatively small planer surface area, the coil blocks 35, and the sensor 109 are arranged side by side as seen in sectional view. Efficient use of space is achieved in those regards, which contributes to reductions in thickness and size.

Next, the assembly procedures for the camera module 100 and the optical module 21 according to the fifth embodiment are described.

The coil spring 47 is placed on the base plate 23 to which the guide shafts 46 is fixed in advance through press fitting or the like. The lens barrel holder 45 to which the nut member 52 is fixed is overlaid on the coil spring 47 along the guide shafts 46. Further, the coil blocks 35 are overlaid on predetermined positions of the base plate 23, and the yoke 36 is further overlaid on the coil blocks 35. Thereafter, fastening is effected with the screw 103 to prevent the yoke 36 from being lifted up as the lens barrel holder 45 slides upward along the guide shafts 46 due to the reaction force of the coil spring 47. Next, the operation of arranging the reduction gear train 29 of the rotor 37 or the like in place, screwing the feed screw 51 into the nut member 52 from above, is performed. Subsequently, the cover 25 is overlaid from above and the screw 102 is screwed in. It is to be noted that, in screwing the feed screw 51 into the nut member 52, the through-hole 61 serves as a guide for the feed screw 51, thus facilitating assembly.

Throughout the series of operations described above, the respective components are assembled onto the base plate 23 in an overlaid manner, thereby enabling good workability.

After those operations, the circuit board 22, on which electronic parts such as the sensor 109, the image pickup element 30, the motor driver 105, the control portion 111 are mounted, is attached onto the base plate 23. At this time, the sensor 109 is fixed to a predetermined position of the base plate 23, and the signal terminal portion from the motor driver 105 equipped in the circuit board 22 is connected to the terminal board 107. Further, the lens barrel 27 is screwed into the lens barrel holder 45.

The optical module 21 and the camera module 100 can be assembled in this way.

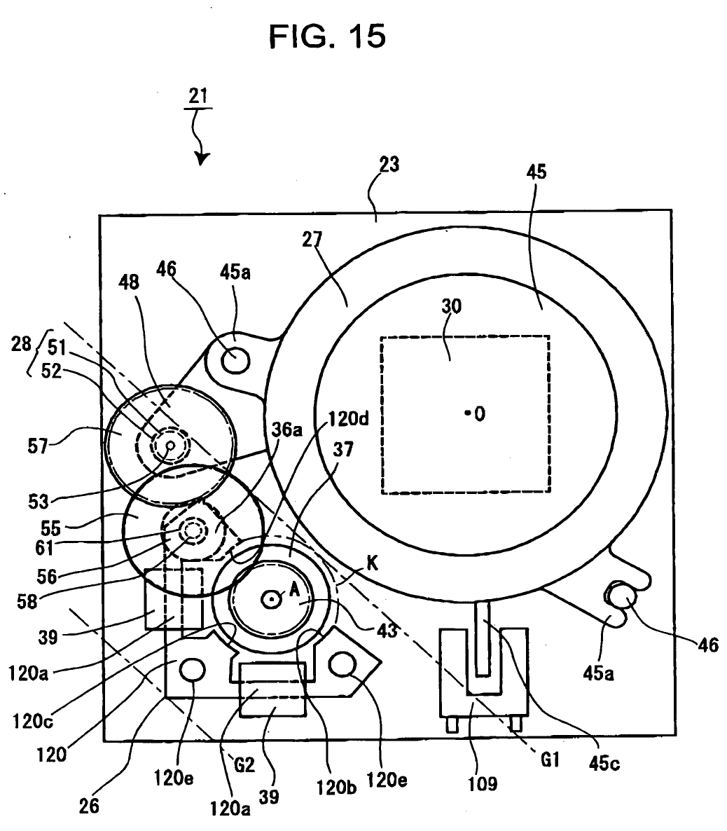

Referring to FIG. 15, a sixth embodiment of the present invention is described. Since an optical module according to this embodiment is basically the same as that of the first embodiment, the structures that are the same as those of the first embodiment are denoted by the same symbols and their description is omitted, and differences from the first embodiment are described below.

In the sixth embodiment, the stepping motor 26 is composed of a magnetic path forming member 120 having two excitation coils 39, and the rotor 37.

The excitation coils 39 are each wound around a core portion 120a of the magnetic path forming member 120.

The magnetic path forming member 120 is generally configured such that it surrounds the rotor 37 yet does not completely enclose the rotor 37, thus leaving an opening K. In this example, the magnetic path forming member 120 has a crescent shape. The coils 39 can be wound easily by using the opening K, thus facilitating the manufacturing process. The magnetic path forming member 120 has magnetic pole ends 120b, 120c, and 120d in close proximity to the rotor 37. The magnetic pole ends 120b and 120d are installed at the opposite ends of the magnetic path forming member 120 having a crescent shape. The magnetic pole end 120c is installed between the two excitation coils 39, that is, at a position in the vicinity of the neutral position of the crescent shape. The magnetic path forming member 120 is adapted such that an S-pole or an N-pole appears in each of the magnetic pole ends 120a, 120b, and 120c each time a drive pulse is applied to each excitation coil 39.

While in the first embodiment the iron core and the yoke are separate components, in this embodiment, the iron core and the yoke are integrated with each other to form the magnetic path forming member 120.

A through-hole 120e provided in the magnetic path forming member 120 can be used for fixation or positioning of the magnetic path forming member 120. Further, the magnetic path forming member 120 includes the through-hole 61 through which the gear shaft 58 is passed, so that a part of the magnetic path forming member 120 is situated between the rotor 37 and the gear shaft 58. That is, the gear 55 is not arranged on the opening K side with respect to the rotor 37 but is arranged on the magnetic path portion 36a side situated on the side opposite to the opening K with respect to the rotor 37. The gear 55 thus overlaps the coil 39. Accordingly, the gear train 29 and the moving means 28 can be arranged within an area defined by G1 and G2 partitioning the width of the stepping motor 26 in the direction perpendicular to the line two-dimensionally connecting the optical axis O and the rotor axis A, thus achieving reduced planar size of the optical module 21. It is to be noted that the same effect can also be attained by arranging the gear shaft 58 between the rotor 37 and the magnetic path forming member 120 or the excitation coils 39.

Further, the opening K placed between the rotor 37 and the optical part 27 serves to shorten the distance between G1 and G2, thereby enabling a further reduction in the size of the optical module 21.

Further, the line two-dimensionally connecting the optical axis O and the rotor axis A forms an acute angle with respect to one side of the optical module 21 which defines the substantially rectangular shape, with the two coils 39 being arranged substantially along two adjacent sides of the optical module 21 which define the substantially rectangular shape. This allows the stepping motor 26 to be disposed by using the redundant space produced upon combining the circular shape of the optical part 27 with the rectangular shape of the optical module 21.

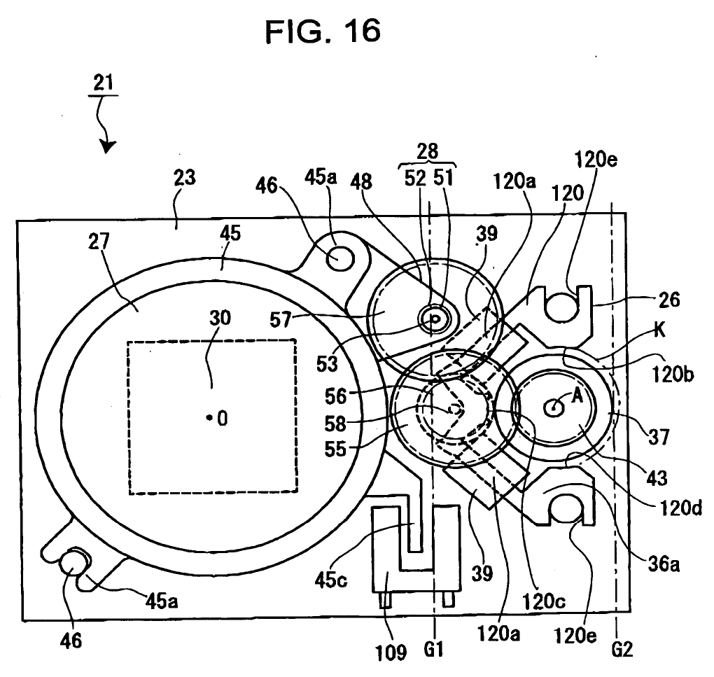

Referring to FIG. 16, a seventh embodiment of the present invention is described. Since an optical module according to this embodiment is basically the same as those of the first and sixth embodiments, the structures that are the same as those of the first or sixth embodiment are denoted by the same symbols and their description is omitted, and differences from the first embodiment are described below.

The magnetic path forming member 120 is arranged between the gear shafts 53 and 58 and the rotor 37. Further, the opening K is arranged outside the gap between the rotor 37 and the optical part 27. That is, the magnetic path forming member 120 is installed between the rotor 37 and the optical part 27.

The above arrangement allows efficient use of the portions of the space between G1 and G2 where the stepping motor 26 is not arranged. In this example, the moving means 2B and the sensor 109 are also disposed by using this space. Further, the opening K can be arranged so as to extend along one side of the rectangular shape defining the outer shape of the optical module 21 which is substantially a rectangle, whereby the distance between G1 and G2 can be shortened, which contributes to miniaturization of the optical module 21. The present invention is not restricted to the above-described embodiments. For example, apart from a focusing operation, the optical part may be moved to effect a zooming operation. Further, instead of the construction using the feed screw and the nut member, the moving means may be constructed such that a barrel cam is moved through rotation of the gear shaft 53, with an optical part such as a lens barrel being moved by this cam.

1. An optical module comprising:
an optical part that is moved in a direction of an optical axis by moving means;
a stepping motor including an excitation coil, a magnetic path forming member having a magnetic pole end, and a rotor; and
a gear train that operatively couples power output from the stepping motor to the moving means.

2. An optical module comprising:
an optical part that is moved in a direction of an optical axis by moving means;
a stepping motor serving as a power source for driving the optical part; and
a gear train that operatively couples power output from the stepping motor to the moving means,
wherein the stepping motor comprises: a magnetic path forming member having a core portion extending in a direction skewed with respect to the direction of the optical axis, and at least three magnetic pole ends; at least two excitation coils each wound around the core portion; and a rotor having its axis arranged in a direction skewed with respect to the direction in which the core portion extends.

3. An optical module according to claim 1, wherein at least one of gear shafts of the gear train is arranged within a projected area of the stepping motor.

4. An optical module comprising, on a base plate having a substantially polygonal shape:
an optical part that is moved in a direction of an optical axis by moving means;
a stepping motor including an excitation coil, a magnetic path forming member having a magnetic pole end, and a rotor; and
a gear train that operatively couples power output from the stepping motor to the moving means,
wherein the excitation coil is wound around the magnetic path forming member along a direction substantially parallel to at least one side of the substantially polygonal shape.

5. An optical module according to claim 1, wherein the magnetic pole end comprises a rotor pass-through hole provided in the magnetic path forming member.

6. An optical module according to claim 1, wherein the magnetic path forming member comprises a coil block having a core portion, and a yoke connected to the coil block and having the magnetic pole end.

7. An optical module according to claim 1, wherein the magnetic path forming member has an opening not surrounding the rotor.

8. An optical module according to claim 1, wherein at least one of gear shafts of the gear train is arranged within a projected area of the stepping motor.

9. An optical module according to claim 1, wherein the magnetic path forming member has at least one shaft insertion portion comprising one of a through-hole and a cutout, and wherein at least one of gear shafts of the gear train is passed through the shaft insertion portion.

10. An optical module according to claim 1, wherein at least one of gear shafts of the gear train is passed through a gap between the magnetic path forming member and a coil block.

11. An optical module according to claim 6, wherein the rotor is arranged between the coil block and the optical part.

12. An optical module according to claim 1, wherein the gear train and the moving means are positioned opposite to each other with the magnetic path forming member therebetween.

13. An optical module according to claim 1, further comprising a detection portion for detecting a position of the optical part, the detecting portion being arranged at a position opposite to the moving means with respect to a line connecting the optical axis and an axis of the rotor.

14. An optical module according to claim 1, further comprising a detection portion for detecting a position of the optical part, the detection portion at least partially overlapping a projected area of the stepping motor.

15. An optical module according to claim 7, wherein the opening is arranged between the optical part and the rotor.

16. An optical module according to claim 7, wherein a part of the magnetic path forming member is arranged between the optical part and the rotor.

17. An optical module according to claim 1, wherein a lens barrel holder coupling the optical part and the moving means together, the magnetic path forming member, the moving means, the rotor, the gear train, and a gear support that supports the gear train together with abase plate to which the stepping motor is fixed, can be assembled from one direction with respect to the base plate.

18. An optical module according to claim 1, further comprising a plurality of screw-fixing means for coupling a yoke and a coil block together and fixing the yoke and the coil block to a base plate, wherein at least one of the plurality of screw-fixing means is screw-fastened in place without the intermediation of a gear support that supports, together with the base plate, respective gear shafts constituting the gear train.

19. A camera module comprising the optical module as claimed in claim 1, an image pickup element for converting an optical image into an electrical signal, and a control portion for controlling operation of the image pickup element.
